(19) United States
(12) Patent Application Publication
(10) Pub. No.: US 2003/0223142 A1
(43) Pub. Date: Dec. 4, 2003

(54) Method and device for data storage using wireless communication

(75) Inventors: Shunichi Mizuhiki, Sayama-shi (JP); Makoto Hashimoto, Ome-shi (JP); Koichi Kobayashi, Tachikawa-shi (JP)

Correspondence Address: PILLSBURY WINTHROP, LLP, P.O. BOX 10500, MCLEAN, VA, 22102, US

(73) Assignee: Kabushiki Kaisha Toshiba, Tokyo (JP)

(21) Appl. No.: 10/453,511

(22) Filed: Jun. 4, 2003

(30) Foreign Application Priority Data
Jun. 4, 2002 (JP) 2002-162877

(51) Int. Cl. G11B 19/04; G11B 5/02

(52) U.S. Cl. 360/60; 360/55

(57) ABSTRACT

A portable data storage device has a wireless data communications function. A CPU of the device writes data transmitted by a radio wave from a communications object device to a data storage medium. At the time of writing, the CPU generates transfer control information including a range of the transmitted data and identification information of the communications object device. When a wave reception state of the device has become poor, the CPU stops the writing to the data storage medium. When communications connection has been resumed, the CPU performs control to continue the writing from a point where the writing was stopped, on the basis of the transfer control information.

### CROSS-REFERENCE TO RELATED APPLICATIONS

This application is based upon and claims the benefit of priority from the prior Japanese Patent Application No. 2002-162877, filed Jun. 4, 2002, the entire contents of which are incorporated herein by reference.

### BACKGROUND OF THE INVENTION

1. Field of the Invention

This invention relates to an electronic device having a wireless data communications function, in particular, a technique to be applied to a portable data storage device which can record data received in the form of a radio wave on a recording medium.

2. Description of the Related Art

Recently, a technique of performing data transfer between personal computers, or between a personal computer and a peripheral device, by using short-range wireless data communications, in particular, has been put into practical use. As a developed form of such a technique, a portable data storage device having a wireless data communications unit has been proposed.

The portable data storage device is a dedicated terminal including a disk drive, such as a hard disk drive (HDD) and a magnetic optical disk drive, or a flash memory as a storage medium, and recording data demodulated from a radio wave received by its wireless data communications unit on the storage medium. A transmitting source of data is an information device, such as a digital camera. The digital camera has a wireless data communications unit, and transmits data of taken images by a radio wave to the portable data storage device.

The portable data storage device can store a large amount of image data since it has a storage medium having a large capacity, such as a disk drive. When storing data, the portable data storage device is connected to the digital camera by wireless communications, and thus it is possible to greatly ease restrictions on operating the digital camera, unlike the case where they are connected by a cable. Specifically, the user can store data of images taken by the digital camera in the storage medium of the portable data storage device, placed distantly from the digital camera, in real time.

Although the portable data storage device having a wireless data communications function is very useful, if a radio wave which is being transferred is interrupted, data writing into the storage medium is interrupted. In particular, a short-range wireless communications unit has a short effective communications range with an information device which transfers data. Therefore, if the distance between the portable data storage device and the information device increases, sometimes a wave reception state (that is, data reception state) of the portable data storage device becomes poor.

If such a poor radio wave reception state occurs during data writing, data writing to the portable data storage device is forcibly interrupted. Therefore, data recording becomes unstable, e.g. a part of data which is being written is erased, and only partial data among data to be written is recorded on the storage medium. Therefore, if the data reception state becomes poor, it is desirable to stop data writing in the storage medium to prevent erase of the data, etc.

However, when the data reception state becomes satisfactory and wireless communications connection with the information device which transfers data is resumed, generally data transfer is performed again from the beginning. Therefore, the portable data storage device repeats writing of the same data as that, whose writing was interrupted, to the storage medium from the beginning. Thus, as a matter of course, the data which was written into the storage medium before wireless communications connection has been interrupted is wasted.

To avoid such a situation, it is desirable to effectively use existing data which has been recorded on the storage medium before interruption of the writing, and record data following the existing data on the storage medium. In short, when the wireless communications connection has been resumed, the portable data storage device performs continued writing. However, performing such an operation requires general users to perform complicated and troublesome operations.

### BRIEF SUMMARY OF THE INVENTION

In accordance with one embodiment of the present invention, there is provided a data storage device including a wireless communications unit. The data storage device has a structure of stopping data writing to a storage medium when a radio wave received by a wireless data communications function is unallowably weak, and continuing the writing at the point of interruption when wireless communications connection is resumed.

The data storage device comprises:

an antenna device for wireless communications connection with a device being a communications partner;

a receiving unit which demodulates data from a radio wave transmitted from the communications partner device via the antenna device;

a unit which generates transfer control information including identification information to identify the communications partner device connected by wireless communications, and information indicating a range of the data transmitted from the communications partner device;

a data storage medium to record the data demodulated by the receiving unit;

a writing controller which stops writing of the data onto the data storage medium when a wave reception state of the receiving unit has become unallowable during writing; and

a data transfer controller which requests, when the wireless communications connection has been resumed, the communications object device being a transfer source of the data, the writing of which was stopped, to transfer data following data which has been recorded on the data storage medium, in accordance with the transfer control information.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a structure of a portable data storage device according to an embodiment of the present invention;

FIG. 2 is a block diagram for explaining a data writing control operation concerning the embodiment;

FIG. 3 is a diagram for explaining contents of transfer control information concerning the embodiment;

FIG. 4 is a flow chart for explaining a writing control operation concerning the embodiment;

FIG. 5 is a flow chart for explaining operations of a device of the other party concerning the embodiment; and

FIG. 6 is a flow chart for explaining a writing control operation at the time of resuming communications connection concerning the embodiment.

### DETAILED DESCRIPTION OF THE INVENTION

An embodiment of the present invention will now be explained with reference to the drawings.

(Structure of Portable Data Storage Device)

FIG. 1 is a block diagram showing a main part of a portable data storage device having a wireless communications function according to the embodiment.

The device 1 comprises a disk drive 10 serving as a storage medium, a microprocessor (CPU) 11, an antenna 12, an antenna module 13, a memory 14, a battery 15, and a regulator circuit 16.

The disk drive 10 is assumed to be a hard disk drive (HDD) using a disk storage medium. The CPU 11 is operated by a program stored in the memory 14, and controls the whole device.

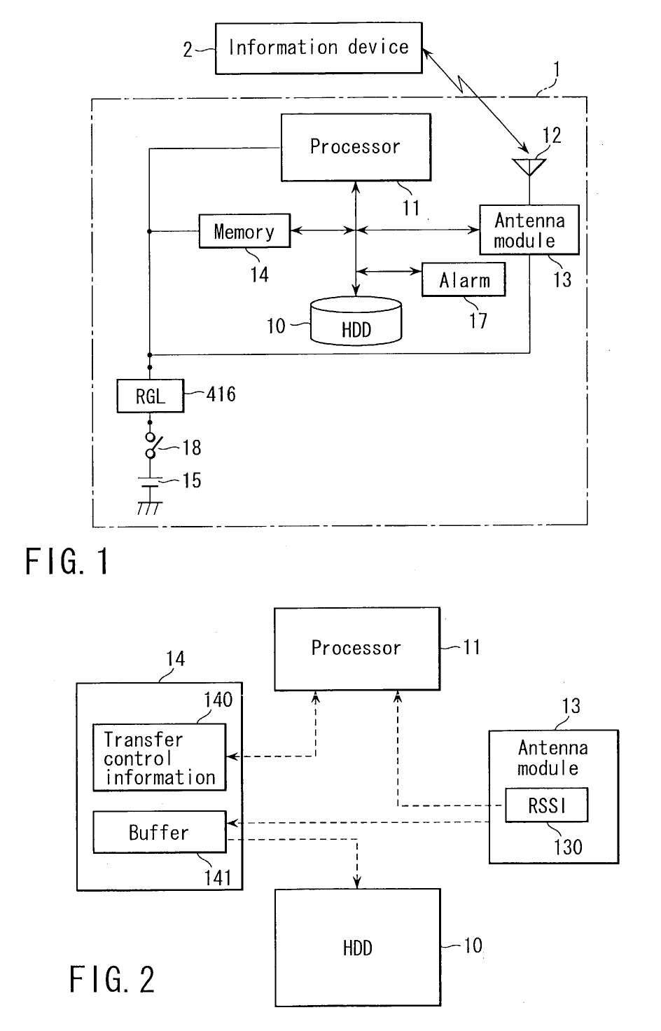

In addition to the program, the memory 14 includes a storage region 140 which stores transfer control information, and a buffer region 141 which temporarily stores data to be written into the HDD 10 (please refer to FIG. 2), as described later. The memory 14 is formed of, for example, a flash EEPROM.

The antenna module 13 is a circuit which controls transmission and reception of data through the antenna 12, and realizes a function of wireless data communications between an information device 2 being the other party of communications. The battery 15 and the regulator circuit 16 form a power supply unit for supplying power for activating the whole device. The power supply switch 18 controls the power supply from the power supply unit to supply it or cut it off.

The device 1 of the present invention further comprises an alarm unit 17 controlled by the CPU 11. The alarm unit 17 issues an alarm to the user when data writing into the HDD 10 has been interrupted.

(Data-writing Control Operation)

The data-writing control operation of the embodiment will now be explained, with reference to FIGS. 2 to 6, in addition to FIG. 1.

The device 1 is assumed to be a portable data storage device which receives, by the antenna 12, a radio wave (for example, a radio wave obtained by modulating image data) transmitted from an information device 2 (a device which the device 1 is to communicate with), and stores it in the HDD 10. The information device 2 is a digital camera or the like having a wireless data communications function.

The antenna module 13 demodulates the radio wave received by the antenna 12 into data (e.g. image data), and transfers the data to the buffer region 141 of the memory 14 (please refer to FIG. 2). The CPU 11 successively reads the data stored in the buffer region 141, and transfers them to the HDD 10. The HDD 10 writes the transferred data on the disk storage medium, by control of a CPU in the drive.

As shown in FIG. 2, the antenna module 13 includes an RSSI (Reserved Signal Strength Indication) unit 130 for monitoring the reception state of a radio wave received by the antenna 12 (in short, data reception state). The RSSI unit 130 detects intensity of an electric field of a radio wave received by the antenna 12, and holds the detection result as RSSI information.

At the time of data writing, the CPU 11 reads the RSSI information (α) from the RSSI unit 130 of the antenna module 13 at a predetermined timing (step S1). Further, the CPU 11 reads, from the memory 14, determination information (β) for determining whether the state of the received radio wave is allowable or not (step S2). The determination information (β) is information corresponding to reference electric field intensity information, which indicates an allowable limit value of a radio wave state. The determination information is stored in advance in a predetermined storage region of the memory 14.

Further, from the memory 14, the CPU 11 reads reading interval data (γ) which corresponds to intervals of sampling the RSSI information (step S3). Specifically, the CPU 11 determines whether the state of radio wave is allowable or not on the basis of the RSSI information, at the intervals indicated by the reading interval data (step S6).

(Transfer Control Information)

Furthermore, with establishment of wireless communications connection with the device 2 with which the device 1 communicates, the CPU 11 generates transfer control information for controlling writing of data transmitted from the device 2, and stores the information in the predetermined storage region 140 in the memory 14 (step S4).

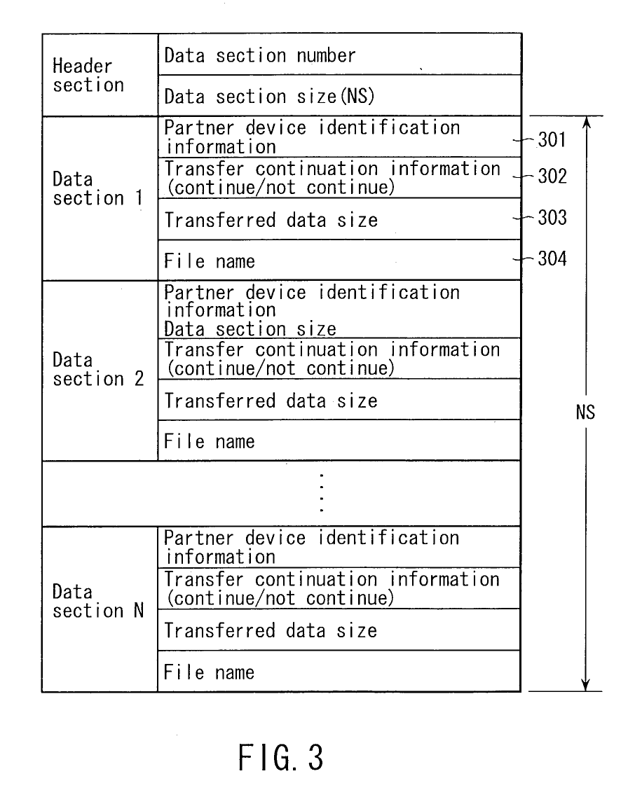

The transfer control information is divided broadly into a header section and data sections, as shown specifically in FIG. 3. The header section is information representing the number of the data sections (N) and the size of the whole data sections (NS). Each of the data sections (1-N) comprises partner device identification information 301, transfer continuation information 302, transferred data size 303, and a file name 304 of the data stored in the disk storage medium of the HDD 10. The partner device identification information 301 is information of an address or the like by which the information device 2 being an object of communications can be identified. The transfer continuation information 302 is flag information for instructing whether or not to perform continued data transfer (data writing) at the time of reconnection (resumption of communications connection) concerning the embodiment. In this embodiment, generally the transfer is continued, and the user can cancel the function.

The transferred data size 303 is information, which is transferred from the information device 2 being the other party of communications and indicates a range of data (specified by the file name 304) stored in the disk storage medium of the HDD 10.

As described below, the transfer control information is also stored in the information device 2 being the other party of communications connection.

(Data Transfer and Writing Operation)

Before data writing, the CPU 11 acquires, through the antenna module 13, the partner device identification information 301 for identifying the information device 2 with which the wireless communications connection has been established, and stores it as an item of the transfer control information stored in the memory 14 (step S5).

Next, the CPU 11 compares the acquired RSSI information (α) with the determination information (β) and, if the intensity of the electric field of the received radio wave is greater than the reference value (α<β), executes data writing into the HDD 10 (steps S6 and S9). Specifically, the CPU 11 transfers the received data (image data in the embodiment) buffered in the memory 14 to the HDD 10.

The CPU 11 continues the data writing for the time indicated by the reading interval data (γ), and stores the size of the written data, as a transferred data size in the transfer control information (step S10).

Further, the CPU 11 determines whether transfer of data to be stored has been completed or not (step S1). When transfer of all the data transmitted from the information device 2 has been completed, the CPU 11 terminates the data writing into the HDD 10 (YES of step S11). At the time of termination, the CPU 11 deletes information of the data section corresponding to the data (specified by the file name) transfer of which has been completed (i.e., writing has been completed) from the transfer control information (140) stored in the memory 14 (step S12).

If writing is not completed within the predetermined time (γ), the CPU 11 determines whether the radio wave state is allowable or not (NO of step S11). The CPU 11 acquires new RSSI information (α) from the antenna module 13, and determines whether the state of the received radio wave is allowable or not, on the basis of the determination information (β). Specifically, the CPU 11 updates the RSSI information (α) by reading new RSSI information (α) from the antenna module 13 at predetermined time intervals (γ).

The CPU 11 compares the acquired RSSI information (α) with the determination information (β) and, if the intensity of an electric field of the received radio wave does not exceed the reference value (α≦β), the CPU stops data writing into the HDD 10 (step S7). Specifically, the CPU 11 stops data transfer from the memory 14 to the HDD 10. Therefore, at this point of time, the antenna module 13 has already demodulated the radio wave received by the antenna 12 into data, and transferred the data to the memory 14. Thus, the CPU 11 controls the alarm unit 17, and the alarm unit 17 outputs an alarm for notifying of stop of the data writing to the HDD 10 (step S8).

As described above, when the wave reception state has become poor while data transmitted from the external information device 2 by a radio wave is being written into the disk storage medium of the HDD 10, the apparatus 1 stops data writing into the HDD 10, and gives an alarm to the user. Thereby, when the intensity of the received radio wave has weakened, the data writing into the HDD 10 can be stopped before starting it, and thus it is possible to prevent the situation that the data is erased. Further, since the user can recognize, by the alarm, that the radio reception state has become poor and the data writing into the HDD 10 has been stopped, the user can take suitable measures.

(Resumption of Communications Connection)

In this embodiment, the transfer control information (140) for managing the data which has been transferred (written) before the data transfer (writing) is stopped is stored in the memory 14. The operation concerning the resumption (continue of writing) of communications connection using the transfer control information will now be explained.

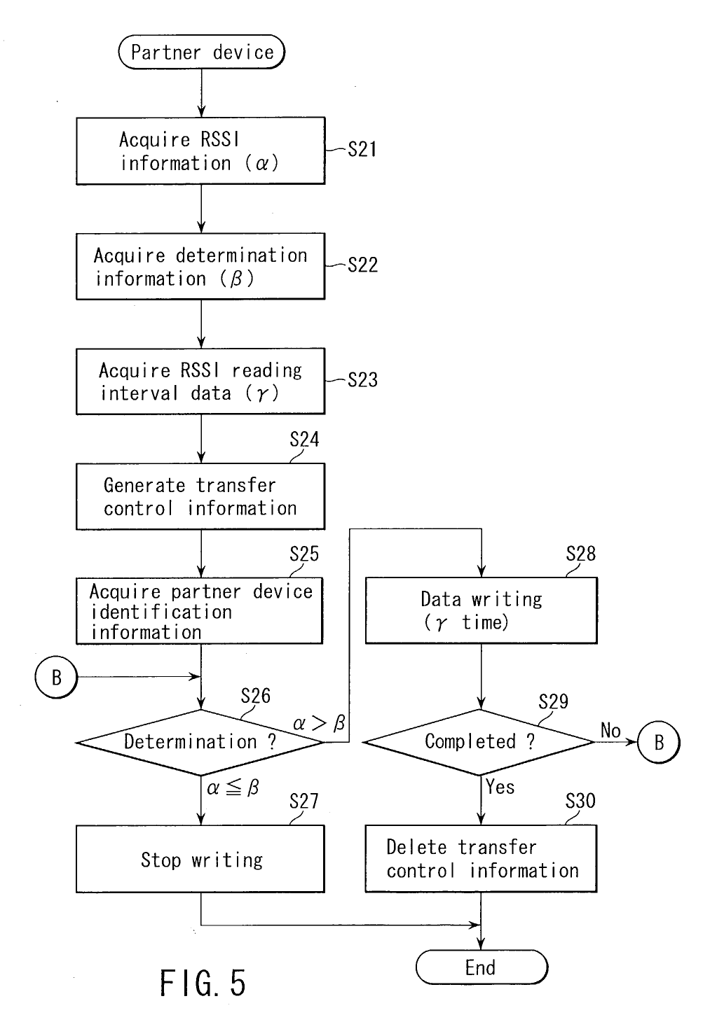

With reference to the flow chart of FIG. 5, data transfer of the information device 2 being the partner of communications will now be described.

The device 2, which the device 1 communicates with, executes basically the same operations as those of the device 1, except that the device 2 transfers data to be recorded to the device 1 (i.e. writing).

Specifically, at the time of data writing (data transfer), the information device 2 reads RSSI information (α) from an RSSI circuit of an antenna module at a predetermined timing (step S21). Further, the information device 2 acquires determination information (β) for determining whether the wave reception state is allowable or not, and reading interval data (γ) (steps S22, S23).

On the basis of the RSSI information, the information device 2 determines whether the wave reception state is allowable or not, at time intervals indicated by the reading interval data (γ). If the intensity of the electric field of the received wave is greater than a reference value (α<β), the device 2 executes data writing to the device 1 (steps S26, S28).

With establishment of wireless communications connection with the device 1, the information device 2 also generates transfer control information similar to that generated by the device 1, and stores the information in a memory (step S24). Further, prior to data writing, the information device 2 also acquires the partner device identification information for identifying the device 1 which has established wireless communications connection, and stores it in the memory as an item of the transfer control information in the memory (step S25).

When transfer of all the data has been finished, the information device 2 deletes information of the data section concerning the data from the transfer control information stored in the memory (YES of step S29, and step 30). In the meantime, if the wave reception state has become poor during data writing operation, the information device 2 stops the data writing operation (steps S26 and S27).

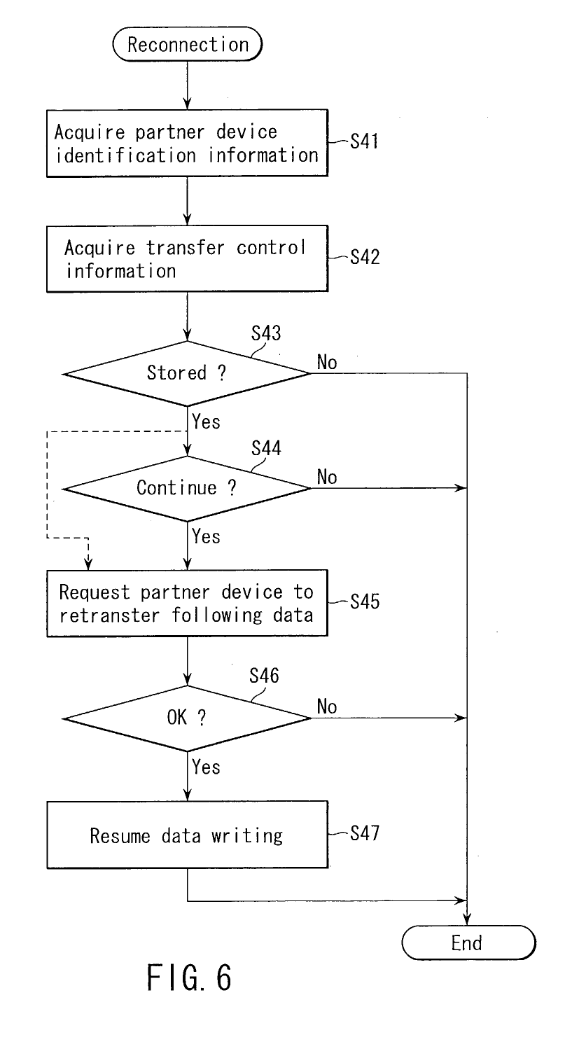

Next, with reference to the flow chart of FIG. 6, data transfer control (writing operation control) performed with resumption of wireless communications connection in the device 1.

First, when the wave reception state of the antenna 12 has become satisfactory and wireless communications connection between the device 1 and the information device 2 has been resumed, the CPU 11 acquires, through the antenna module 13, the partner device identification information for identifying the information device 2, and the transfer control information stored in the information device 2 (steps S41 and S42). Also at the time of resumption of communications connection, the CPU 11 compares the RSSI information (α) acquired from the RSSI circuit 130 of the antenna module 13 with the determination information (β), thereby determines whether the wave reception state has become allowable or not. In the same manner, the CPU 11 also reads the reading interval data (γ) corresponding to the sampling intervals of the RSSI information.

Further, the CPU 11 refers to the transfer control information (140) stored in the memory 14, and searches it for data section information including the partner device identification information 301 being the same as the identification information acquired from the information device 2. If the data section information is not stored, the CPU 11 terminates processing involved in the reconnection (NO of step S43).

If the data section information exists, the CPU 11 takes out the data section information from the transfer control information (140) stored in the memory 14, and refers to the information together with the transfer control information (data section information) acquired from the information device 2 (step S44). If the transfer continuation information (302) of any of the transfer control information is set to flag information indicating “not continue”, the processing involved in the reconnection is terminated (NO of step S44).

If both of the transfer continuation information (302) are set to flag information indicating “continue”, the CPU 11 requests data retransfer of the information device 2 (YES of step S44 and step S45). At this time, the CPU 11 transfers to the information device 2 the transferred data size (written data size 303) and the file name which are recorded as the data section information of the transfer control information (140).

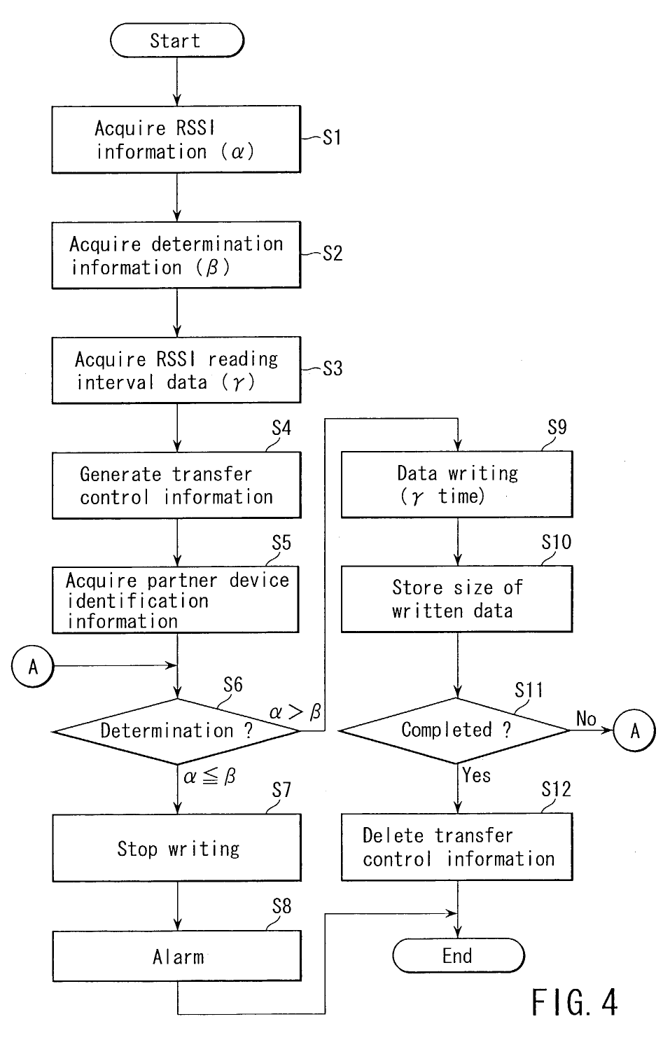

In response to such a request, the information device 2 transfers data following the transferred data before transfer from the information device 2 is stopped. When the following data has been transferred to the device 1, the CPU 11 executes data writing into the HDD 10 (steps S46 and S47). Specifically, in the HDD 10, the data following the data recorded on the disk storage medium before the writing was stopped due to a poor wave reception state is written on the disk storage medium. Also in resumption of the writing, the processing from the step S9 to step S12 shown in FIG. 4 is repeated.

(Modification)

In the method shown in FIG. 6, it is determined, on the basis of the transfer information acquired from the information device 2 and the transfer continuation information (302), whether writing of the data following the data recorded before the writing was stopped is to be executed or not (step S44).

Generally, in the case of using a portable data storage device, if transmission of data has been resumed after interruption of a writing operation, it is desirable to continue writing of the following data without condition.

Therefore, as a modification, as shown in FIG. 6, when wireless communications connection between the device 1 and the information device 2 is resumed, the CPU 11 acquires, via the antenna module 13, the partner device identification information for identifying the information device 2, and the transfer control information (14) stored in the memory 14 (steps S41 and S42).

In this step, if the memory 14 does not store any transfer control information (140), it means that the writing of the data transmitted from the information device 2 has been completed (please refer to YES of step S11 in FIG. 4). Therefore, the CPU 11 terminates the processing involved in the reconnection (NO of step S43).

In the meantime, if the transfer control information (140) is stored in the memory 14, the CPU 11 searches the transfer control information (140) for data section information (a data section in which identification information of the information device 2 is recorded). Then, as indicated by a broken line in FIG. 6, the CPU 11 requests data retransfer of the information device 2 (YES of step S43, and step 45).

In this step, the CPU 11 transfers, to the information device 2, the size of the transferred data (written data size 303) and the file name which are recorded as data section information of the transfer control information (140). Thereby, when the information device 2 has transferred data following the data recorded before transfer from the information device 2 was stopped, the CPU 11 executes data writing into the HDD 10 (steps S46 and S47).

According to this modification, it is not necessary to acquire the transfer control information from the information device 2. Further, the transfer control information (140) has no need of including transfer continuation information 302.

In short, the portable data storage device 1 having the wireless communications function according to this modification can automatically continue data transfer (data writing) from the interrupted point, if communications connection is resumed after the data transfer (data writing) has been interrupted due to deterioration of a communications state between the device 1 and the information device 2 which the device 1 communicates with. Therefore, it is possible to effectively use the data recorded on the disk storage medium of the HDD 10 before interruption of the writing operation, without wasting it.

Further, when the wave reception state becomes satisfactory and wireless communications connection with the information device 2 being a data transmitting source is resumed, the user can automatically continue a writing operation to record data following the existing data, without performing complicated and troublesome operations.

Although a storage medium in this embodiment is assumed to be the HDD 10 using a disk storage medium, it is not limited to it, but may be a magnetic optical disk drive using a magnetic optical disk, or a flash memory using a flash EEPROM. Further, although the alarm device 17 is assumed to be a device which give an alarm to the user, it is not limited to it, but may be a device which displays a warning message on an LCD (liquid crystal display).

Furthermore, generally the device 1 is to be applied to a portable external storage unit such as a card-shaped memory.

As described above in detail, according to the above embodiment, if a wave reception state of a portable data storage device having a wireless data communications function has become poor, the device stops writing into a storage medium. Further, when a wireless communications connection has been resumed by restoration of the satisfactory wave reception state, it is possible to automatically continue the writing operation from data following the data recorded before interruption of the writing operation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data storage device, comprising:
an antenna device for wireless communications connection with a device being a communications partner;
a receiving unit which receives data transmitted by the device via the antenna device;
a generating unit which generates transfer control information to identify the device, and to indicate a range of the data received from the device;
a data storage medium to record the data;
a recording controller which stops recording the data onto the data storage medium when a radio wave reception state of the receiving unit has become unallowable during recording; and
a data transfer controller which requests, when the wireless communications connection has been resumed, the device to transfer data following data which has been recorded by the recording controller on the data storage medium, in accordance with the transfer control information.

2. The data storage device according to claim 1, wherein the receiving unit includes an antenna module which senses an intensity of an electric field concerning the wave reception state and generates the electric field intensity information, and
the writing controller determines, at the time of writing, the wave reception state on the basis of the electric field intensity information and stops the writing if the wave reception state is unallowable.

3. The data storage device according to claim 1, wherein
the writing controller resumes writing, to the data storage medium, of the data transmitted from the communications partner device in response to the data transfer controller as data following an interruption point of writing.

4. The data storage device according to claim 1, further comprising:
a memory unit to store the generated transfer control information.

5. The data storage device according to claim 1, further comprising:
a memory unit to store the generated transfer control information; and
a controller which deletes the transfer control information concerning the data from the memory unit, when the data writing to the data storage medium by the writing controller has been completed.

6. The data storage device according to claim 1, further comprising:
a memory unit to store the generated transfer control information; and
a controller which deletes the transfer control information concerning the data from the memory unit, when the data writing to the data storage medium by the writing controller has been completed,
wherein the data transfer controller refers, when the wireless communications connection has been resumed, to the memory unit and, if the transfer control information is stored in the memory unit, requests the communications partner device being a transfer source of the data, the writing of which was stopped, to transfer data following data which has been recorded on the data storage medium, in accordance with the transfer control information.

7. The data storage device according to claim 1, wherein the data storage medium is a disk drive or a flash memory.

8. The data storage device according to claim 1, comprising a portable data storage device.

9. A method of data write control for a data storage device having an antenna to perform wireless data communications with a device being a communications partner, and a data storage medium to store data demodulated from a radio wave received by the antenna,
the method comprising:
generating transfer control information including identification information to identify the communications object device and information indicating a range of the data transferred from the communications object device, after establishment of the wireless communications connection with the communications object device;
determining whether a wave reception state of the antenna is unallowable or not, during writing of the received data to the data storage medium;
stopping writing of the data received to the data storage medium, when it has been determined in the determining that the wave reception state is unallowable; and
requesting, when the wireless communications connection has been resumed, the communications object device being a transfer source of the data, the writing of which was stopped, to transfer data following data which has been recorded on the data storage medium, in accordance with the transfer control information.

10. The method according to claim 9, further comprising:
sensing an electric field intensity of the radio wave received by the antenna and generating information of the electric field intensity; and
determining, at the time of data writing, the wave reception state on the basis of the electric field intensity information and stopping the writing if the wave reception state is not allowable.

11. The method according to claim 9, further comprising:
resuming writing, to the data storage medium, of the data transferred from the communications object device being the transfer source as data following an interruption point of writing.

12. The method according to claim 9, further comprising:
storing the generated transfer control information in a memory unit.

13. The method according to claim 9, further comprising:
storing the generated transfer control information in a memory unit; and
deleting the transfer control information concerning the data from the memory unit, when the data writing to the data storage medium has been completed.

14. The method according to claim 9, further comprising:
storing the generated transfer control information in a memory unit; and
deleting the transfer control information concerning the data from the memory unit, when the data writing to the data storage medium has been completed; and
referring, when the wireless communications connection has been resumed, to the memory unit and, if the transfer control information is stored in the memory unit, requests the communications partner device being a transfer source of the data, the writing of which was stopped, to transfer data following data which has been recorded on the data storage medium, in accordance with the transfer control information.
